(19) United States
(12) Patent Application Publication
(10) Pub. No.: US 2015/0307101 A1
(43) Pub. Date: Oct. 29, 2015

(54) VEHICLE AND METHOD TO CONTROL ROLLING ENGAGEMENTS

(71) Applicant: FORD GLOBAL TECHNOLOGIES, LLC, Dearborn, MI (US)

(72) Inventors: SCOTT PATRICK RIES, South Lyon, MI (US); KENDRICK MORRISON, Wayne, MI (US)

(73) Assignee: FORD GLOBAL TECHNOLOGIES, LLC, Dearborn, MI (US)

(21) Appl. No.: 14/263,141

(22) Filed: Apr. 28, 2014

(51) Int. Cl. B60W 30/18; B60W 10/184; F16H 61/16; B60W 10/115; B60W 30/188; B60W 30/186

(52) U.S. Cl. CPC B60W 30/18045; B60W 30/1884; B60W 30/186; F16H 61/16; B60W 10/115; B60W 10/184; F16H 2061/165; F16H 2061/166

(57) ABSTRACT

When a vehicle driver commands a change in direction of motion while the vehicle is moving above a threshold speed, a controller first applies a braking force to slow the vehicle below the threshold speed and then establishes a power flow path associated with the opposite direction of motion. The braking force may be applied by wheel brakes or, in some situations, by a transmission clutch. This method prevents an engine stall, overheating of oncoming clutch, and excessive delay.

### TECHNICAL FIELD

This disclosure relates to the field of automatic transmission controls. More particularly, the disclosure pertains to a method of employing a braking system to reduce vehicle speed before engaging an opposite direction gear ratio.

### BACKGROUND

Many vehicles are used over a wide range of vehicle speeds, including both forward and reverse movement. Some types of engines, however, are capable of operating efficiently only within a narrow range of speeds. Consequently, transmissions capable of efficiently transmitting power at a variety of speed ratios are frequently employed. Transmission speed ratio is the ratio of input shaft speed to output shaft speed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising. Generally, transmissions include at least one negative speed ratio which is engaged when the driver selects reverse.

Many automatic transmissions implement a discrete number of different transmission ratios in which each ratio is establish by engaging a particular subset of clutches. Clutches may include devices that couple two rotating elements to one another and devices which couple a rotating element to a stationary element. To shift from one speed ratio to another speed ratio, one clutch, called the off-going clutch, is released and another clutch, called the oncoming clutch, is engaged. To maintain power transfer during an upshift, the oncoming clutch must absorb energy. Designing the clutch to absorb and then dissipate this energy may involve increasing the friction area or fluid flow rate above what would be required simply to have adequate torque capacity. Increasing friction area and fluid flow rate increase the parasitic drag when the clutch is open reducing fuel efficiency. Some types of clutches, such as dog clutches, have no capability to absorb energy. When the oncoming clutch is a dog clutch, the elements to be coupled by the dog clutch must be at the same speed before engagement.

When the vehicle is stationary, the gearbox input is also stationary even for very high speed ratios. Since an internal combustion engine cannot generate torque at zero crankshaft speed, a launch device is necessary to permit the engine to rotate and transmit torque to the gearbox input. Many automatic transmission utilize a torque converter having an impeller driven by the engine crankshaft and a turbine driving the gearbox input shaft. Torque is transferred from the impeller to the turbine whenever the impeller rotates faster than the turbine. Torque is transferred in the opposite direction when the turbine rotates faster than the impeller.

When a driver shifts from drive to reverse while the vehicle is moving forward or from reverse to drive while the vehicle is moving backwards, the gearbox input shaft and turbine rotate backwards. The load on the engine is higher when the turbine rotates backwards than when the turbine is stationary. If the backwards speed of the turbine is too high, the load on the engine may cause the engine to stall. Since the backwards speed of the turbine is proportional to the vehicle speed, a controller may inhibit the shift until the vehicle speed is below a threshold, placing the transmission in neutral in the meantime. However, the deceleration rate of the vehicle in neutral is low, so this approach may delay engagement of the desired gear ratio may for an excessive amount of time. An alternative approach is to apply the oncoming clutch gradually to avoid exerting excessive load on the engine. However, this approach may force the oncoming clutch to absorb and dissipate more energy than it is capable of absorbing and dissipating.

### SUMMARY OF THE DISCLOSURE

A vehicle includes a transmission, a braking system, and a controller. The braking system may include friction brakes located at each wheel and arranged to apply a braking torque in response to a command from the controller. The controller commands the braking system to slow the vehicle in response to a command from the driver, such as by depressing a brake pedal. The controller is also programmed to command the braking system to slow the vehicle in response to the driver moving a shift lever while the vehicle is moving. For example, the controller commands the braking system to slow the vehicle if the driver moves the shift lever from a Drive position to a Reverse position while the vehicle is moving forward at a speed above a threshold. Similarly, the controller commands the braking system to slow the vehicle if the driver moves the shift lever from a Reverse position to a Drive position while the vehicle is moving backward at a speed above a threshold.

A method of controlling a vehicle includes responding to a change of position of a shift lever from a position corresponding to one direction of motion to a position corresponding to the opposite direction of motion by applying a first friction element to slow the vehicle to a speed less than a threshold before engaging a second friction element to establish the commanded power flow path. The change in shift lever position may be from Drive to Reverse or from Reverse to Drive. The first friction element may be a wheel brake.

A controller includes input communication channels, output communications channels, and control logic. The input communications channels receive a signal from a shift lever and may also receive a signal from a brake pedal. The output communications channels send command signals to a transmission and may also send command signals to a set of wheel brakes. The control logic is programmed to respond to movement of the shift lever indicating a change in intended direction of motion while the vehicle is moving by commanding a braking system to reduce vehicle speed and then, when vehicle speed is less than a threshold, by commanding the transmission to establish a power flow path corresponding to the opposite direction of vehicle movement.

### BRIEF DESCRIPTION OF THE DRAWINGS

FIG. 1 is a schematic representation of a vehicle powertrain and braking system.

FIG. 2 is a schematic representation of a gearbox arrangement.

FIG. 3 is a flow chart for a method of engaging a forward gear while moving in reverse.

FIG. 4 is a flow chart for a method of engaging a reverse gear while moving forward.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

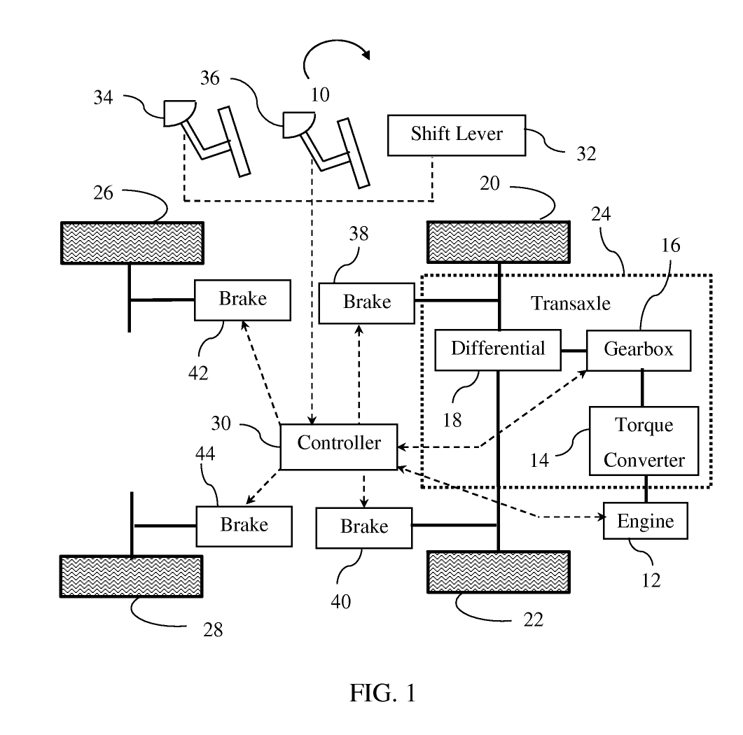

A front wheel drive (FWD) vehicle powertrain 10 is illustrated schematically in FIG. 1. Mechanical connections are indicated by solid lines and signals are indicated by broken lines. Power is provides by internal combustion engine 12. Torque converter 14 includes an impeller driven by the engine crankshaft and a turbine. The turbine is fixed to the input shaft of gearbox 16. The torque converter also includes a bypass clutch which selectively couples the impeller to the turbine. When the bypass clutch is engaged, torque is transferred by the bypass clutch. When the bypass clutch is disengaged, torque is transferred hydro-dynamically between the impeller and the turbine. Gearbox 16 includes a number of planetary gear sets and clutches interconnected to establish a variety of power flow paths, each with a distinct speed ratio, by selective engagement of the clutches. Power is transferred from an output element of gearbox 16 to differential 18. The power may be transferred by means of meshing gears or by means of a chain. The transfer may also multiply the torque and reduce the speed by a fixed final drive ratio. Differential distributes the power to left and right front wheels 20 and 22 allowing slight speed differences as the vehicle turns a corner. The torque converter, gearbox, and differential may collectively be called a transaxle or a transverse transmission. A rear-wheel drive vehicle powertrain has similar components although the engine, torque converter, gearbox, and differential are located along the vehicle centerline and drive rear wheels 26 and 28. The present invention is applicable to both front wheel drive and rear wheel drive powertrain configurations.

The engine and gearbox respond to commands from controller 30. The controller sends signals to gearbox 16 to apply particular clutches. The controller sends signals to engine 12 indicating what amount of torque to produce. Controller 30 receives signals from a shift lever 32, an accelerator pedal 34, and a brake pedal 36. The driver moves shift lever 32 among several positions to indicate the desired direction of travel. A D position indicates a desire to move forward. An R position indicates a desire to move backwards. An N position indicates a desire for neutral. A P position indicates a desire to engage park. The term shift lever is used here to represent any user interface element intended to indicate these choices including, for example, a console mounted lever, a steering wheel mounted lever, or a touch screen. Controller 30 may be implemented, for example, as a single micro-processor or as multiple communicating micro-processors.

Each wheel is associated with a friction brake 38, 40, 42, and 44 which applies torque to slow the wheel in response to a command from controller 30. Typically, controller 30 would issue such a command in response to the driver depressing brake pedal 36. However, the brake system command is not necessarily proportional to the brake pedal depression. The controller may limit the brake torque to avoid wheel slip or, in a hybrid electric vehicle, may coordinate the friction brake torque with regenerative braking supplied by a motor.

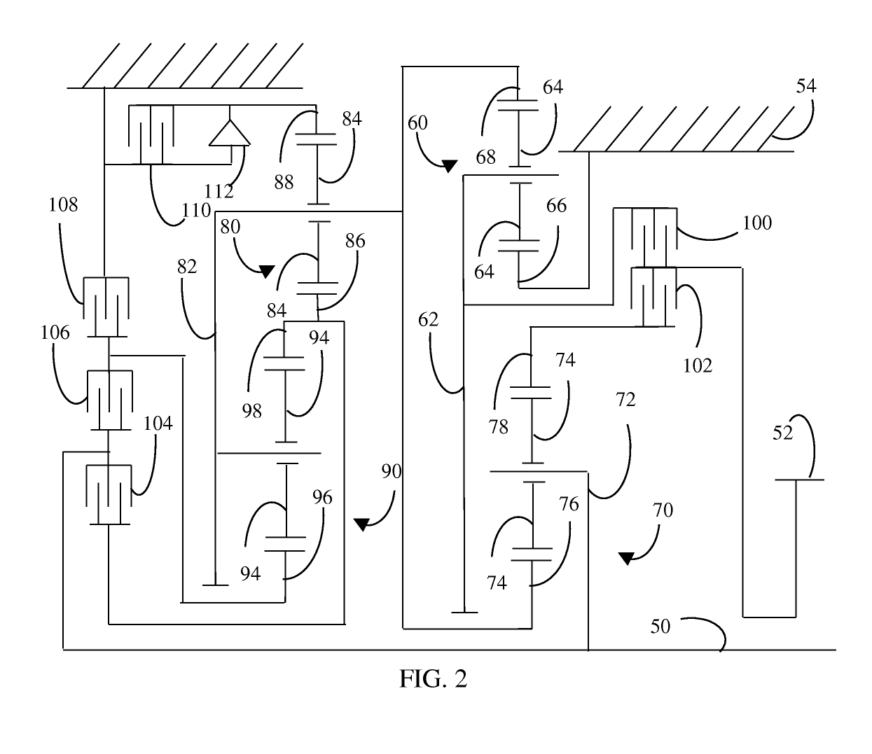

An exemplary arrangement of gearbox 16 is illustrated in FIG. 2. Gearbox 16 includes an input shaft 50 driven by the torque converter turbine, an output element 52, and a transmission case 54 fixed to vehicle structure. Gearbox 16 also includes four simple planetary gear sets 60, 70, 80, and 90. Each simple planetary gear set includes a sun gear having external gear teeth, a ring gear having internal gear teeth, and a carrier supporting a set of planet gears that mesh with both the sun gear and the ring gear. Finally, gearbox 16 includes a set of clutches including hydraulically actuated friction clutches 100, 102, 104, 106, 108, and 110 and passive one way clutch 112. Carrier 72 is fixedly coupled to input shaft 50. Carrier 82 (which is common to gear set 80 and 90), ring gear 68, and sun gear 76 are mutually fixedly coupled. Sun gear 86 is fixedly couple to ring gear 98. Sun gear 66 is fixedly coupled to transmission case 54. Output shaft 52 is selectively coupled to carrier 62 by clutch 100 and selectively coupled to ring gear 78 by clutch 102. Input shaft 50 is selectively coupled to ring gear 98 and sun gear 86 by clutch 104 and selectively coupled to sun gear 96 by clutch 106. Sun gear 96 is selectively held against rotation by clutch 108. Ring gear 84 is selectively held against rotation by clutch 110 and passively restrained from rotation in one direction by one way clutch 112. The clutches of gearbox 16 are engaged in combinations of three to establish nine forward speed ratio power flow paths and one reverse speed ratio power flow path as shown in Table 1.

TABLE 1

| | 100 | 102 | 104 | 106 | 108 | 110/112 | Ratio | Step |
|---|---|---|---|---|---|---|---|---|
| Rev | X | | | X | | X | −3.09 | 69% |
| 1st | X | | X | | | X | 4.47 | |
| 2nd | X | | X | | X | | 2.66 | 1.68 |
| 3rd | X | | X | X | | | 1.68 | 1.58 |
| 4th | X | X | | | | | 1.23 | 1.36 |
| 5th | | X | X | X | | | 1.00 | 1.23 |
| 6th | | X | X | | X | | 0.84 | 1.19 |
| 7th | | X | X | | | X | 0.76 | 1.11 |
| 8th | | X | | | X | X | 0.66 | 1.15 |
| 9th | | X | | X | | X | 0.56 | 1.19 |

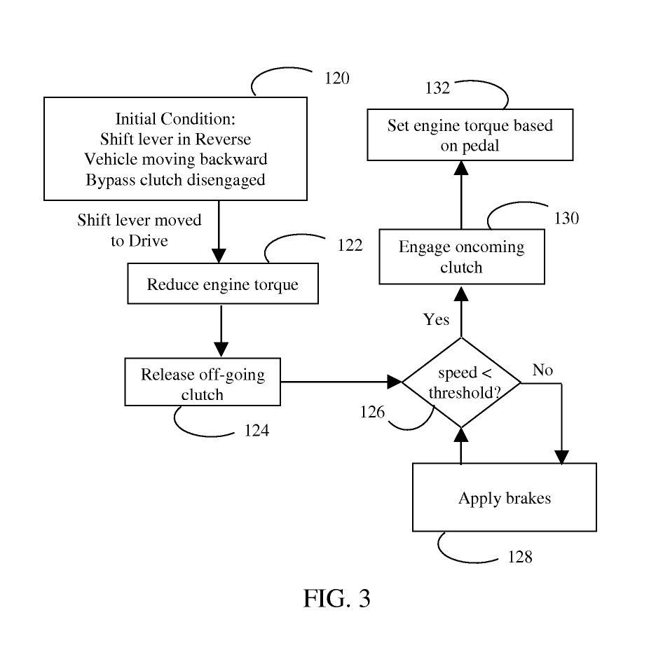

A method of controlling a vehicle during a direction change from reverse to forward is illustrated in FIG. 3. The method is initiated at 120 with the vehicle moving backwards with the shift lever in reverse. In reverse, controller 30 has engaged clutches 100, 106, and 110. The term engaged is used here to mean that no relative rotation is allowed across the clutches. In reverse, the torque converter bypass clutch is typically disengaged. In response to the driver moving the shift lever to the drive position, the controller reduces engine torque at 122 and releases the off-going clutch at 124 placing the transmission in a neutral state. At 126, the controller checks to determine whether the vehicle speed is below a threshold. Speed is considered to be positive whether the vehicle is moving forward or backwards. If the speed is not less than the threshold, brakes are applied at 128 until the speed is below the threshold. The term applied is used here to mean that torque is transferred but relative rotation may still occur. Applying brakes may involve applying friction brakes 38, 40, 42, and 44. Alternatively, in a hybrid vehicle the braking system may include one or more motors capable of reducing vehicle speed. As long as the clutches that establish the reverse speed ratio remain engaged, transmission clutches 102 or 108 may also be considered part of the braking system because applying either of them reduces vehicle speed. Using a transmission clutch as a vehicle brake may be desirable if the transmission controller is not configured to control the wheel brakes. Since these clutches are both designed to be oncoming clutches during upshifts, they may have more thermal capacity than clutch 104. Once the vehicle has decelerated below the threshold speed, clutch 104 is engaged at 130 to establish first gear ratio. If the oncoming clutch 104 is a dog clutch, then a threshold speed close to zero is desireable. Once the first gear ratio is established, the controller resumes commanding engine torque based on accelerator pedal position at 132.

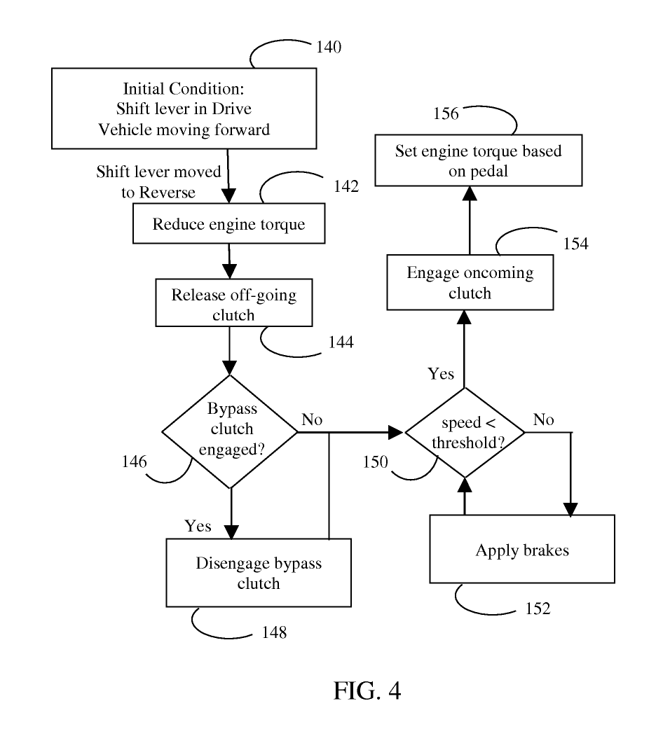

A method of controlling a vehicle during a direction change from forward to reverse is illustrated in FIG. 4. The method is initiated at 140 with the vehicle moving forward with the shift lever in drive. The transmission may be in any forward gear. The torque converter bypass clutch may or may not be engaged depending on vehicle speed. In response to the driver moving the shift lever to the reverse position, the controller reduces engine torque at 142 and releases at least one off-going clutch at 144. At 146, the controller checks whether the torque converter bypass clutch is engaged. If so, it disengages it at 148. At 150, the controller checks to determine whether the vehicle speed is below a threshold. If the speed is not less than the threshold, brakes are applied at 152 until the speed is below the threshold. Once the vehicle has decelerated below the threshold speed, at least one oncoming clutch is engaged at 154 to establish the reverse gear ratio. Once the reverse gear ratio is established, the controller resumes commanding engine torque based on accelerator pedal position at 156.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a transmission configured to selectively establish a plurality of power flow paths;
a braking system configured to slow the vehicle in response to a driver command; and
a controller programmed to respond to movement of a shift lever while the vehicle is moving in a current direction by commanding the braking system to slow the vehicle before commanding the transmission to establish a power flow path corresponding to an opposite direction.

2. The vehicle of claim 1 wherein the braking system comprises friction brakes and commanding the braking system to slow the vehicle comprises commanding application of the friction brakes.

3. The vehicle of claim 1 wherein the current direction is forward and the opposite direction is reverse.

4. The vehicle of claim 1 wherein the current direction is reverse and the opposite direction is forward.

5. A method of controlling a vehicle comprising:
responding to a change of position of a shift lever from a first position corresponding to a current direction of motion to a second position corresponding to an opposite direction of motion by applying a first element to slow the vehicle and then, after a vehicle speed decreases to a threshold, engaging a second element to establish a power flow path associated with the second position.

6. The method of claim 5 wherein the current direction of motion is forward, the first position is a drive position, and the second position is a reverse position.

7. The method of claim 5 wherein the current direction of motion is backward, the first position is a reverse position, and the second position is a drive position.

8. The method of claim 5 wherein the first element is a wheel brake.

9. The method of claim 5 wherein the second element is a dog clutch.

10. The method of claim 5 wherein the threshold is non-zero.

11. A controller comprising:
input communications channels configured to receive a signal from a shift lever;
output communications channels configured to send command signals to a transmission; and
control logic programmed to respond to movement of the shift lever from a position corresponding to a current direction of vehicle movement to a position corresponding to an opposite direction of vehicle movement by commanding a braking system to reduce vehicle speed and then, when vehicle speed is less than a threshold, commanding the transmission to establish a power flow path corresponding to the opposite direction of vehicle movement.

12. The controller of claim 11 further comprising:
input communications channels configured to receive a signal from a brake pedal;
output communications channels configured to send command signals to a plurality of wheel brakes; and
wherein commanding the braking system to reduce vehicle speed comprises sending commands to the wheel brakes to exert torque.

13. The controller of claim 11 wherein the current direction of vehicle movement is forward, the opposite direction of vehicle movement is backward, and the power flow path establishes a reverse speed ratio.

14. The controller of claim 11 wherein the current direction of vehicle movement is reverse, the opposite direction of vehicle movement is forward, and the power flow path establishes a forward speed ratio.
